(19) United States
(12) Patent Application Publication
(10) Pub. No.: US 2016/0340832 A1
(43) Pub. Date: Nov. 24, 2016

(54) AQUEOUS COMPOSITION COMPRISING A POLYVALENT METAL COMPLEXED BY CARBONATE AND CARBOXYLIC ACID LIGANDS, AND USE THEREOF

(71) Applicant: ARCHROMA FRANCE SAS, Trosly-Breuil (FR)

(72) Inventors: Damien Julien CORPET, Oslon (FR); Christine Jeannine LETOFFET CABELLO RODRIGUEZ, Dommiers (FR); Virginie Angele Georgette BERDON, Trosly-Breuil (FR)

(73) Assignee: ARCHROMA FRANCE SAS, Trosly-Breuil (FR)

(21) Appl. No.: 15/110,959

(22) PCT Filed: Jan. 29, 2015
(86) PCT No.: PCT/EP2015/000174

§ 371 Date: Jul. 12, 2016

(30) Foreign Application Priority Data
Jan. 30, 2014 (EP) 14000349.2

(51) Int. Cl. D21H 19/46; D21H 19/64; C09D 7/12

(52) U.S. Cl. CPC D21H 19/46; C09D 7/1216; C09D 7/1233; D21H 19/64

(57) ABSTRACT

The invention relates to a zinc based aqueous composition comprising at least a carbonate and a carboxylic acid, prepared from a zinc compound, a carbonate, and a carboxylic acid, and to its use as insolubilizing agent in a coating bath for fiber-based substrates, like paper, board, non woven or textiles.

The present invention relates to an aqueous composition comprising a complex of a polyvalent metal complexed by at least one carbonate ligand and at least one carboxylic acid ligand, and to the use of said composition as insolubilizing agent in coating baths for the treatment of fiber-based substrates, like paper, board, non woven and textiles.

U.S. Pat. No. 4,350,788 teaches that zinc oxide pigments can be used to crosslink adhesive polymers. It is known that zinc oxide pigments can be used to render insoluble, in aqueous solution, synthetic binders, such as latexes or polyvinyl alcohol, and to form insoluble films, thus improving the resistance to water, to friction, to heat and to solvents.

However, as the zinc oxide pigment, in its solid form, provides only a limited reactive surface, the use of these powders has the disadvantage of providing only very limited efficiency. Thus, the use of these pigments does not give satisfactory results, particularly as regards the resistance of the coating to wet rub.

U.S. Pat. No. 3,740,366 and EP 0 182 628 teach that aqueous polyvalent metal complexes, like zinc diglycinate (ZDG), can be used to render insoluble, in aqueous solution, synthetic binders, such as latexes or polyvinyl alcohol, and to form insoluble films, thus improving the resistance to water, to friction, to heat and to solvents.

These polyvalent metal diglycinate solutions are used in numerous technological fields, in particular in aqueous ink and paint formulations and possibly in coating baths intended for the coating or impregnation of paper or board in order to improve the appearance, the wet abrasion resistance, the picking, the strength and the ability to receive printing.

However, the use of these solutions has the disadvantage of providing only very limited efficiency. Thus, the use of these compositions does not give satisfactory results, particularly as regards the resistance of the coating to wet rub.

WO 99/06478 teaches that polyvalent metal complexes, such as zinc diacetate (ZDA) solutions, can be used to crosslink polymers. It is known that aqueous compositions of these complexes can be used to render insoluble, in aqueous solution, synthetic binders, such as latexes or polyvinyl alcohol, and to form insoluble films, thus improving the resistance to water, to friction, to heat and to solvents. In WO 99/06478 it is described that these aqueous compositions comprising a polyvalent metal complex, like zinc diacetate, are used in aqueous polymer dispersions.

However, these compositions are not used in pigmented coating baths intended for the coating or impregnation of paper or board, as the use of these compositions has the disadvantage of showing strong incompatibilities with standard pigmented coating baths of paper and textile industries. This incompatibility results in the destabilization of common coating baths and strong increases of viscosity, rendering the coating baths unusable for application.

It was therefore an object of the present invention to provide novel aqueous compositions of polyvalent metals in complexed form to be used in the textile and/or paper industry, in particular compositions being compatible with standard pigmented coating baths and providing coatings with an improved resistance to wet rub.

This object is solved by the aqueous composition according to claim 1.

Embodiments of the aqueous composition according to the invention are subject-matter of the thereon dependent claims.

### SUMMARY OF THE INVENTION

Surprisingly, it has been found that an aqueous composition comprising a complex comprising at least one polyvalent metal wherein the at least one polyvalent metal is complexed by at least one carbonate ligand and at least one carboxylic acid ligand, wherein the carboxylic acid ligand is preferably functionalized with at least one further hydrophilic group, makes it possible to obtain satisfactory resistances to wet rub, while maintaining complete compatibility with standard pigmented coating baths.

Thus, in a first aspect the present invention relates to an aqueous composition comprising a complex comprising at least one polyvalent metal, wherein the at least one polyvalent metal is complexed by at least one carbonate ligand and at least one carboxylic acid ligand.

Preferably, the carboxylic acid ligand is functionalized with at least one further hydrophilic group.

In a particular embodiment, the at least one polyvalent metal is selected from transition metals and main group metals. Preferably, the at least one polyvalent metal is zinc or aluminum.

In a particular embodiment, the source of the at least one polyvalent metal is selected from the corresponding metal carbonate, metal chloride, metal oxide, metal sulphate, and mixtures or combinations thereof.

Preferably, the source of the at least one polyvalent metal is selected from zinc carbonate, zinc chloride (ZnCl₂), zinc oxide, zinc sulphate, aluminum chloride, aluminum oxide, aluminum sulphate, and mixtures and combinations thereof.

In a particular embodiment, the molar ratio between the at least one carbonate ligand and the at least one carboxylic acid ligand is at least about 10 molar %, preferably at least about 20 molar %, even more preferably at least about 30 molar %, and up to about 65 molar %, preferably up to about 60 molar %, even more preferably up to about 50 molar %, most preferably between about 30 and about 50 molar % of carbonate ligand; and at least about 35 molar %, preferably at least about 40 molar %, even more preferably at least about 50 molar %, and up to about 90 molar %, preferably up to about 80 molar %, and most preferably up to about 70 molar %, most preferably between about 50 and about 70 molar % of carboxylic acid ligand, wherein the amount of carboxylic acid ligand and carbonate ligand is in total 100 molar %.

In a particular embodiment, the at least one carboxylic acid ligand is functionalized with at least one further hydrophilic group selected from: alcohol group, amine group, amide group, sulfonic acid group, carboxylic acid group, ester group, phosphorus-oxygen acid group, carbonate group, and combinations thereof.

In a particular embodiment, the source of the at least one carbonate ligand is selected from an inorganic carbonate salt, e.g. the source of the at least one carbonate ligand is selected from sodium hydrogenocarbonate, ammonium carbonate, ammonium hydrogenocarbonate, potassium hydrogenocarbonate, and combinations or mixtures thereof.

In a particular embodiment, the source of the at least one carboxylic acid is selected from glycolic acid, lactic acid, glycine, and combinations or mixtures thereof.

In a particular embodiment, the source of the at least one polyvalent metal is selected from zinc oxide, zinc carbonate, and combinations or mixtures thereof; and the source of the at least one carbonate ligand is selected from potassium hydrogenocarbonate, ammonium hydrogenocarbonate, and combinations or mixtures thereof; and the source of the at least one carboxylic acid ligand is selected from glycolic acid, lactic acid, glycine, and combinations or mixtures thereof.

In a particular embodiment, the pH value of the composition is alkaline. Preferably, the pH value of the composition is more than 7, or more than about 8, or more than about 9, and less than about 10.

In a particular embodiment, the concentration of Zn or Al ions, expressed as ZnO or Al₂O₃, is in the range of from about 3 to about 20% by weight.

In a particular embodiment, the composition further comprises at least one additive. Preferably, said at least one additive is selected from the group consisting of stabilizing agents.

In another aspect, the present invention relates to a method of manufacturing of the composition as disclosed herein, which comprises the admixing of at least one salt of a polyvalent metal and with at least one carbonate salt and at least one carboxylic acid.

In yet another aspect, the present invention relates to a method of coating a fiber-based substrate, e.g. a cellulose-based substrate, such as a paper, board, non woven or textile substrate, comprising the step of contacting said substrate with the composition as disclosed herein.

In yet another aspect, the present application relates to the use of the composition as disclosed herein as an insolubilizing agent in an aqueous composition for the treatment, e.g. impregnation or coating, of a fiber-based substrate, e.g. a cellulose-based substrate, such as paper, board, non woven or textile material.

In yet another aspect, the present invention relates to a pigmented coating bath comprising the composition as disclosed herein.

### DETAILED DESCRIPTION OF THE INVENTION

Thus, in a first aspect, the present invention relates to an aqueous composition comprising a complex comprising at least one polyvalent metal, wherein the at least one polyvalent metal is complexed by at least one carbonate ligand and at least one carboxylic acid ligand.

The term “complex” as used herein comprises at least one polyvalent metal which is complexed by at least two ligands.

The complex according to the subject application comprises at least one polyvalent metal which is complexed by at least one carbonate ligand and at least one carboxylic acid ligand.

The term “carbonate” encompasses in principle any type of carbonate known in the art and includes in particular inorganic and organic carbonates. Exemplary carbonates to be suitably used within the ambit of the subject application are sodium hydrogenocarbonate, ammonium carbonate, ammonium hydrogenocarbonate or potassium hydrogenocarbonate, or a mix of such compounds; potassium and ammonium hydrogenocarbonate being preferred.

The carboxylic acid ligand may be derived from any carboxylic acid known in the art. The term “carboxylic acid” encompasses any acid comprising at least one carboxylic acid group. In one embodiment, the carboxylic acid ligand is derived from a monocarboxylic acid. In one embodiment, the carboxylic acid ligand as used within the subject application is functionalized with at least one further hydrophilic group. Said at least one further hydrophilic group may be selected from an alcohol group, amine group, amide group, sulfonic acid group, carboxylic acid group, ester group, phosphorus-oxygen acid group, carbonate group, and combinations thereof.

In one embodiment, the carboxylic acid ligand is derived from acids containing at least one carboxylic acid group and at least one other water soluble group (like alcohol and/or amine) and a mix of such compounds. In a preferred embodiment, the carboxylic acid ligand is derived from a monocarboxylic acid ligand comprising at least one further hydrophilic group; glycolic acid, lactic acid and glycine being preferred.

In the context of the present invention, the term “polyvalent metal” relates to a metal being at least bivalent. The metal may be present in the complex in atomic or ionic form. In one embodiment the metal is present in ionic form.

In a particular embodiment, the at least one polyvalent metal is selected from transition metals and main group metals according to the PSE (periodic system of the elements). In one embodiment, the at least one polyvalent metal is zinc or aluminum.

In a particular embodiment, the source of the at least one polyvalent metal is selected from the corresponding metal carbonate, metal chloride, metal oxide, metal sulphate, and mixtures or combinations thereof.

Preferably, the source of the at least one polyvalent metal is selected from zinc carbonate, zinc chloride (ZnCl₂), zinc oxide, zinc sulphate, aluminum chloride, aluminum oxide, aluminum sulphate, and mixtures and combinations thereof.

The zinc carbonate, zinc chloride (ZnCl₂), zinc oxide, and zinc sulphate which can be used according to the invention are commercial products generally available in the solid form.

Typically, the compositions of the present invention are prepared by reaction of the zinc compound with an aqueous solution of a carbonate and a carboxylic acid. The reaction of the zinc compound with the carbonate and the carboxylic acid can be carried out at ambient temperature or by heating.

According to a preferred embodiment, after having added, at ambient temperature, the zinc compound to the aqueous solution of carbonate and carboxylic acid, the solution obtained is brought with stirring to a temperature of between 30 and 80° C., preferably to 70° C., for 1 h to 24 h, preferably 24 h.

In a particular embodiment, the molar ratio between the at least one carbonate ligand and the at least one carboxylic acid ligand is at least about 10 molar %, preferably at least about 20 molar %, even more preferably at least about 30 molar %, and up to about 65 molar %, preferably up to about 60 molar %, even more preferably up to about 50 molar %, most preferably between about 30 and about 50 molar % of carbonate ligand; and at least about 35 molar %, preferably at least about 40 molar %, even more preferably at least about 50 molar %, and up to about 90 molar %, preferably up to about 80 molar %, and most preferably up to about 70 molar %, most preferably between about 50 and about 70 molar % of carboxylic acid ligand, wherein the amount of carboxylic acid ligand and carbonate ligand is in total 100 molar %.

In a particular embodiment, the at least one carboxylic acid ligand is functionalized with at least one further hydrophilic group selected from: alcohol group, amine group, amide group, sulfonic acid group, carboxylic acid group, ester group, phosphorus-oxygen acid group, carbonate group, and combinations thereof.

In a particular embodiment, the source of the at least one carbonate ligand is selected from an inorganic carbonate salt. Preferably, the source of the at least one carbonate ligand is selected from sodium hydrogenocarbonate, ammonium carbonate, ammonium hydrogenocarbonate, potassium hydrogenocarbonate, and combinations or mixtures thereof.

In a particular embodiments, the source of the at least one carboxylic acid ligand is selected from glycolic acid, lactic acid, glycine, and combinations or mixtures thereof.

In a particular embodiment, the source of the at least one polyvalent metal is selected from zinc oxide, zinc carbonate, and combinations or mixtures thereof; and the source of the at least one carbonate ligand is selected from potassium hydrogenocarbonate, ammonium hydrogenocarbonate, and combinations or mixtures thereof; and the source of the at least one carboxylic acid ligand is selected from glycolic acid, lactic acid, glycine, and combinations or mixtures thereof.

In a particular embodiment, the pH value of the composition is alkaline. Preferably, the pH value of the composition is more than 7, or more than about 8, or more than about 9, and less than about 10.

In a particular embodiment, the concentration, expressed as ZnO or Al₂O₃, is in the range of from about 3 to about 20% by weight. This ratio and the way of determining same, i.e. in the form of the respective oxide, also applies to all other polyvalent metal complexes falling within the ambit of the subject application.

In a particular embodiment, the composition further comprises at least one additive. Preferably, said at least one additive is selected from the group consisting of stabilizing agents.

The stability of the aqueous compositions of the present invention can be improved by the addition of a stabilizing agent as described in the state of the art. In one embodiment, the stabilizing agent is selected from polyacids, such as tartaric acid. The stabilizing agent is advantageously added in the proportion of 1 to 2% approximately with respect to the weight of the final solution. The stabilizing agent may be added before the reaction between the zinc compound and the carbonate or after, preferably before the reaction. In one embodiment, the aqueous composition comprises a stabilizing agent selected from polycarboxylic acids and a complex comprising a polyvalent metal complexed by a carbonate ligand and a monocarboxylic acid ligand functionalized with at least one further hydrophilic group. Preferably, the polycarboxylic acid is present as free acid in the composition.

In another aspect, the present invention relates to a method of manufacturing of the composition as disclosed herein comprising the admixing of at least one salt of a polyvalent metal with at least one carbonate salt and at least one carboxylic acid.

The compositions obtained according to the invention are stable over time and exhibit advantageous properties when they are introduced into compositions for the treatment of fiber-based products, in particular cellulose-based products, and in particular into pigmented coating baths.

They make it possible in particular to improve the wet abrasion resistance, the wet pick resistance and the inertia with regard to water of the substrates treated, such as fiber based substrates, such as non woven, textiles, paper or board; such as, for example, paper of the type for the printing of writing, newsprint, recycled paper, wrapping paper, paper of test liner type, the backing for self-adhesive labels or board in the flat.

Thus, in another aspect, the present invention relates to a method of coating a fiber-based substrate, e.g. a cellulose-based substrate, such as a paper, board, non woven or textile substrate, comprising the step of contacting said substrate with the composition as disclosed herein.

In yet another aspect, the present invention relates to the use of the composition according to the invention as insolubilizing agent in an aqueous composition for the treatment, e.g. impregnation or coating, of a fiber-based substrate, e.g. a cellulose-based substrate, such as paper, board, non woven or textile material.

In yet another aspect, the present invention relates to a pigmented coating bath comprising the composition disclosed herein. Preferably, said coating bath is for the impregnation or coating of paper, board, non woven or textile.

In a particular embodiment, the fiber-based substrate is a cellulose-based product.

In a particular embodiment, the cellulose-based product is selected from paper and board.

In a particular embodiment, the fiber-based product is selected from non woven and textiles.

In the context of the present invention, the term “coating bath” relates to an aqueous mixture comprising at least one binder, an insolubilizing agent and a pigment, and also, optionally, functional additives. Generally, the pigments used are chosen from kaolin, calcium carbonate, titanium dioxide and their mixtures. Other pigments, such as alumina hydrate, satin white, silicates or synthetic pigments, can also be used for specific applications.

In the context of the present invention, the term “insolubilizing agent” refers to a composition able to crosslink the at least one binder comprised in a coating bath, thereby rendering it more hydrophobic. An insolubilizing agent functions to improve the surface characteristics of fiber-based products treated with a coating bath comprising said insolubilizing agent, in particular to improve the wet abrasion resistance of said fiber-based product.

According to a preferred embodiment of implementing the invention, the insolubilizing agent is a zinc based aqueous composition comprising a potassium and/or ammonium hydrogenocarbonate and glycolic acid and/or glycine.

In the present invention, the coating bath can be:
either deposited at the surface over the fiber-based product in one or more layers while limiting the penetration inside the surface to be treated, an operation commonly known as coating;
or brought into contact with the fiber-based product with the objective of obtaining penetration inside the fiber-based product in one or more stages, an operation commonly known as impregnation.

The binders can be of natural or synthetic origin.

Mention may be made, among natural binders, of starch, modified starch (for example oxidized or modified by enzymes), soy protein and casein.

More commonly, use is made of synthetic binders, such as styrene/butadiene latexes, polyvinyl acetate latexes, styrene/acrylate and acrylate latexes or polyvinyl alcohol.

According to a preferred aspect, the binders used in the present invention can be chosen from functionally modified latexes, for example latexes modified with hydroxyl groups, particularly with carboxyl groups, in particular sodium carbon/late groups. Mention may be made, by way of example, of the styrene/butadiene DL 950 latex sold by Dow.

The coating baths which can be used in the present invention can also comprise additives, such as dispersants, viscosity modifiers (carboxymethylcellulose or hydroxyethylcellulose, for example), lubricating agents, bactericides, pH control agents, repellents, gloss agents, dyes or antifoaming agents.

The pH of the said coating baths is generally between 7 and 9, preferably between 7 and 8.7.

Generally, the amount of insolubilizing agent of the present invention in the coating bath is between 1 and 20 parts as is per 100 parts of binder under dry conditions, preferably between 3 and 15 parts as is per 100 parts of binder under dry conditions.

The coating bath is applied by methods known to the person skilled in the art. Mention may be made, by way of example, of the process with an applicator roll, size press or premetering size press.

In another aspect, the present invention relates to a method for treating a fiber-based substrate, preferably paper, board, non woven or textiles, preferable a cellulose-based product, in which a coating bath comprising at least one binder, an insolubilizing agent and a pigment, is applied at the surface of the said fiber-based product, characterized in that the insolubilizing agent is an aqueous composition comprising a complex comprising at least one polyvalent metal, wherein said at least one polyvalent metal is complexed by at least one carbonate ligand and at least one carboxylic acid ligand, as described above. Preferably, said insolubilizing agent is a zinc based aqueous composition comprising a carbonate and a carboxylic acid.

In another aspect, the present invention relates to at a method for treating a fiber-based substrate, like a cellulose-based product, preferably paper or board, non woven or textiles, in which a coating bath comprising at least one binder, an insolubilizing agent and optionally a pigment is brought into contact with said fiber-based product, characterized in that that the insolubilizing agent is an aqueous composition comprising at least one polyvalent metal, wherein said at least one polyvalent metal is complexed by at least one carbonate ligand and at least one carboxylic acid ligand, as described above. Preferably, said insolubilizing agent is a zinc based aqueous composition comprising a carbonate and a carboxylic acid, as described above.

The invention is illustrated without implied limitation by the following examples.

### COMPARATIVE EXAMPLE 1

Use of commercial Zinc oxide nanodispersion, containing 40% of dry ZnO, nanodispersed in water

### COMPARATIVE EXAMPLE 2

Preparation of an ammonium zinc dicarbonate comprising 13% of dry ZnO with regard to the solution as is and 2 mol of carbonate per mole of zinc.

61.7 g of water are put under stirring, at ambient temperature. Subsequently, 25.3 g of ammonium bicarbonate are added, followed by 13.0 g of zinc oxide (purity about 97%). When the addition is complete, the pH of this suspension is adjusted to basic pH with ammonia and then the solution is heated at 77° C. for 4 hours.

The solution is then cooled to 30° C. 100 g of a clear colourless solution having a strong smell of ammonia are obtained.

### COMPARATIVE EXAMPLE 3

Preparation of a zinc diacetate comprising 10% of dry ZnO with regard to the solution as is and 2 mol of acetic acid per mole of zinc.

79.9 g of water are put under stirring, at ambient temperature. Subsequently, 20.1 g of commercial zinc diacetate are added. When the addition is complete, the suspension is stirred until complete dissolution.

100 g of a clear colourless solution are obtained.

### COMPARATIVE EXAMPLE 4

Preparation of a zinc diglycinate comprising 15% of dry ZnO with regard to the solution as is and 2 mol of glycine per mole of zinc.

61.9 g of water are put under stirring, at ambient temperature. Subsequently, 38.1 g of commercial zinc diglycinate are added. When the addition is complete, the pH is adjusted to basic pH with ammonia and then the suspension is stirred until complete dissolution.

100 g of a clear colourless solution are obtained.

### EXAMPLE 5

Preparation of a zinc solution containing both ammonium hydrogenocarbonate and glycinate, with a 50:50 molar ratio of ammonium hydrogenocarbonate and glycinate, and comprising 15% of dry ZnO with regard to the solution as is. 1 mol of carbonate and 1 mol of glycine per mole of zinc were used.

54.8 g of water are put under stirring, at ambient temperature. Subsequently, 14.4 g of glycine are added, followed by 15.6 g of zinc oxide (purity about 97%), followed by 15.2 g of ammonium hydrogenocarbonate. When the addition is complete, the pH of this suspension is adjusted to basic pH with ammonia and then the solution is heated at 78° C. for 2 hours.

The solution is then cooled to 30° C.

100 g of a clear colourless solution are obtained.

### EXAMPLE 6

Preparation of a zinc solution containing both ammonium hydrogenocarbonate and glycinate, with molar ratio of 40% of ammonium hydrogenocarbonate and 60% of glycinate, and comprising 15% of dry ZnO with regard to the solution as is and, so 0.8 mol of carbonate and 1.2 mol of glycine per mole of zinc.

55 g of water are put under stirring, at ambient temperature. Subsequently, 17.2 g of glycine are added, followed by 15.6 g of zinc oxide (purity about 97%), followed by 12.2 g of ammonium hydrogenocarbonate. When the addition is complete, the pH of this suspension is adjusted to basic pH with ammonia and then the solution is heated at 70° C. for 5 hours.

The solution is then cooled to 30° C.

100 g of a clear colourless solution are obtained.

### EXAMPLE 7

Preparation of a zinc solution containing both ammonium hydrogenocarbonate and glycinate, with molar ratio of 30% of ammonium hydrogenocarbonate and 70% of glycinate, and comprising 15% of dry ZnO with regard to the solution as is and, so 0.6 mol of carbonate and 1.4 mol of glycine per mole of zinc.

55.1 g of water are put under stirring, at ambient temperature. Subsequently, 20.2 g of glycine are added, followed by 15.6 g of zinc oxide (purity about 97%), followed by 9.1 g of ammonium hydrogenocarbonate. When the addition is complete, the pH of this suspension is adjusted to basic pH with ammonia and then the solution is heated at 70° C. for 7 hours.

The solution is then cooled to 30° C.

100 g of a clear colourless solution are obtained.

### EXAMPLE 8

Preparation of a zinc solution containing both ammonium hydrogenocarbonate and glycinate, with molar ratio of 20% of ammonium hydrogenocarbonate and 80% of glycinate, and comprising 15% of dry ZnO with regard to the solution as is and, so 0.4 mol of carbonate and 1.6 mol of glycine per mole of zinc.

55.2 g of water are put under stirring, at ambient temperature. Subsequently, 23.1 g of glycine are added, followed by 15.6 g of zinc oxide (purity about 97%), followed by 6.1 g of ammonium hydrogenocarbonate. When the addition is complete, the pH of this suspension is adjusted to basic pH with ammonia and then the solution is heated at 70° C. for 24 hours.

The solution is then cooled to 30° C.

100 g of a clear colourless solution are obtained.

### EXAMPLE 9

Preparation of a zinc solution containing both ammonium hydrogenocarbonate and glycinate, with molar ratio of 10% of ammonium hydrogenocarbonate and 90% of glycinate, and comprising 15% of dry ZnO with regard to the solution as is and, so 0.2 mol of carbonate and 1.8 mol of glycine per mole of zinc.

55.4 g of water are put under stirring, at ambient temperature. Subsequently, 25.9 g of glycine are added, followed by 15.6 g of zinc oxide (purity about 97%), followed by 3.0 g of ammonium hydrogenocarbonate. When the addition is complete, the pH of this suspension is adjusted to basic pH with ammonia and then the solution is heated at 70° C. for 3 hours.

The solution is then cooled to 30° C.

100 g of a clear colourless solution are obtained.

### EXAMPLE 10

Preparation of a zinc lactate carbonate solution, comprising 13.1% of dry ZnO with regard to the solution as is and, so 1 mol of carbonate and 1 mol of lactate per mole of zinc.

58.7 g of water are put under stirring, at ambient temperature. Subsequently, 16.1 g of lactic acid at 90% are added and the pH is adjusted to basic pH with ammonia. Then 13.1 g of zinc oxide (purity about 97%) are added, followed by 12.1 g of ammonium hydrogenocarbonate. When the addition is complete, the solution is heated at 70° C. for 5 hours.

The solution is then cooled to 30° C.

100 g of a clear solution are obtained.

### EXAMPLE 11

Preparation of a zinc lactate carbonate solution, comprising 15% of dry ZnO with regard to the solution as is and, so 0.6 mol of carbonate and 1.4 mol of lactate per mole of zinc.

55.9 g of water are put under stirring, at ambient temperature. Subsequently, 19.2 g of lactic acid at 90% are added and the pH is adjusted to basic pH with ammonia. Then 15.6 g of zinc oxide (purity about 97%) are added, followed by 9.3 g of ammonium hydrogenocarbonate. When the addition is complete, the solution is heated at 70° C. for 24 hours.

The solution is then cooled to 30° C.

100 g of a clear solution are obtained.

### APPLICATION EXAMPLES

Use was made of a calcium carbonate sold by Omya (Hydrocarb® 90), a kaolin sold by Huber Engineered Materials (Hydragloss®), a styrene/butadiene latex sold by Dow (DL 950), and carboxymethylcellulose (CMC) sold by Noviant (Finfix® 10).

Various formulations F0 to F14 were prepared, the compositions of which are given in Tables 1.1 and 1.2 below. The amounts are given as dry parts.

The formulation F0 does not comprise an insolubilizing agent.

The formulation F1 corresponds to the use of a commercial nanodispersion of zinc oxide (Comparative Example 1).

The formulation F2 corresponds to the use of a zinc dicarbonate composition (Comparative Example 2).

The formulation F3 corresponds to the use of a zinc diacetate composition (Comparative Example 3).

The formulation F4 corresponds to the use of a commercial zinc diglycinate (Comparative Example 4).

The formulation F5 corresponds to the use of a zinc, glycinate and carbonate composition, according to the invention, with molar ratio of 50% of ammonium hydrogenocarbonate and 50% of glycinate. (Example 5).

The formulation F6 corresponds to the use of a zinc, glycinate and carbonate composition, according to the invention, with molar ratio of 40% of ammonium hydrogenocarbonate and 60% of glycinate. (Example 6).

The formulation F7 corresponds to the use of a zinc, glycinate and carbonate composition, according to the invention, with molar ratio of 30% of ammonium hydrogenocarbonate and 70% of glycinate. (Example 7).

The formulation F8 corresponds to the use of a zinc, glycinate and carbonate composition, with molar ratio of 20% of ammonium hydrogenocarbonate and 80% of glycinate. (Example 8).

The formulation F9 corresponds to the use of a zinc, glycinate and carbonate composition, with molar ratio of 10% of ammonium hydrogenocarbonate and 90% of glycinate. (Example 9). The formulation F10 corresponds to the use of a zinc, lactate and carbonate composition, with molar ratio of 50% of ammonium hydrogenocarbonate and 50% of lactic acid. (Example 10).

The formulation F11 corresponds to the use of a zinc, lactate and carbonate composition, with molar ratio of 30% of ammonium hydrogenocarbonate and 70% of lactic acid. (Example 9).

TABLE 1.1
(=Comparative examples 1 to 4)

| | F0 | F1 | F2 | F3 | F4 |
|---|---|---|---|---|---|
| calcium carbonate | 50 | 50 | 50 | 50 | 50 |
| kaolin | 50 | 50 | 50 | 50 | 50 |
| latex | 10 | 10 | 10 | 10 | 10 |
| CMC | 0.35 | 0.35 | 0.35 | 0.35 | 0.35 |
| insolubilizing agent | | 2 | | | |
| (Comparative Ex 1) | | | | | |
| insolubilizing agent | | | 2 | | |
| (Comparative Ex 2) | | | | | |
| insolubilizing agent | | | | 2 | |
| (Comparative Ex 3) | | | | | |
| insolubilizing agent | | | | | 2 |
| (Comparative Ex 4) | | | | | |
| pH | 8.7 | 8.7 | 8.7 | 8.75 | 8.7 |

TABLE 1.2
(=Examples according to the invention)

| | F 5 | F 6 | F 7 | F 8 | F 9 | F 10 | F 11 |
|---|---|---|---|---|---|---|---|
| calcium carbonate | 50 | 50 | 50 | 50 | 50 | 50 | 50 |
| kaolin | 50 | 50 | 50 | 50 | 50 | 50 | 50 |
| latex | 10 | 10 | 10 | 10 | 10 | 10 | 10 |
| CMC | 0.35 | 0.35 | 0.35 | 0.35 | 0.35 | 0.35 | 0.35 |
| insolubilizing agent | 2 | | | | | | |
| (Example 5) | | | | | | | |
| insolubilizing agent | | 2 | | | | | |
| (Example 6) | | | | | | | |
| insolubilizing agent | | | 2 | | | | |
| (Example 7) | | | | | | | |
| insolubilizing agent | | | | 2 | | | |
| (Example 8) | | | | | | | |
| insolubilizing agent | | | | | 2 | | |
| (Example 9) | | | | | | | |
| insolubilizing agent | | | | | | 2 | |
| (Example 10) | | | | | | | |
| insolubilizing agent | | | | | | | 2 |
| (Example 11) | | | | | | | |
| pH | 8.7 | 8.7 | 8.7 | 8.7 | 8.7 | 8.7 | 8.7 |

The viscosity of each formulation was measured.

The viscosities were measured with a Brookfield viscometer, at a speed of 100 rpm, and are expressed in mPa·s. Viscosities must stay between 700 and maximum 1000 mPa·s. The results obtained are reported in Tables 2.1 and 2.2 below. When an important viscosity increase is observed, destabilization of the coating bath is also noted, showing the incompatibility of the insolubilizing agent with the coating bath.

TABLE 2.1
(=Comparative examples 1 to 4)

| | F0 | F1 | F2 | F3 | F4 |
|---|---|---|---|---|---|
| Bath viscosity (in mPa · s) | 769 | 645 | 3000 | 8000 | 857 |
| Destabilization | No | No | Yes | Yes | No |

The analysis of the results mentioned in Table 2.1 shows that, with respect to the coating slips prepared according to the techniques of the prior art, the composition F 2, using Zinc Dicarbonate (ZDC), the composition F 3, using Zinc Diacetate (ZDA), both used as comparative examples, give visual destabilisation of the bath, making it not usable for application. Zinc Dicarbonate (ZDC) and Zinc Diacetate (ZDA), both described in the state of art, are not usable.

TABLE 2.2
(=Examples according to the invention)

| | F 0 | F 5 | F 6 | F 7 | F 8 | F 9 | F 10 | F 11 |
|---|---|---|---|---|---|---|---|---|
| Bath viscosity | 769 | 754 | 756 | 780 | 724 | 756 | 800 | 1000 |
| (in mPa · s) | | | | | | | | |
| Destabilization | No | No | No | No | No | No | No | No |

The analysis of the results mentioned in Table 2.2 shows that compositions according to the invention (examples 5-11) do not have the drawback to destabilize the bath and allow to obtain usable baths.

In the examples, use was made of uncoated paper exhibiting a grammage of 80 g/m².

The paper was coated with the formulations F 0, F 4 to F 11 with a deposition of approximately 20 g/m² using a threaded rod, followed by oven drying at 105° C. in an oven for 2 minutes.

The Taber wet abrasion was subsequently determined on the coated paper.

The Taber wet abrasion was carried out according to amended French Standard Q 03-055, with annular test specimens with outer and inner diameters of 120 and 7 mm respectively, with 10 revolutions, CS O wheels, under a pressure of 1N, in the presence of 10 ml of water, followed by rinsing with 10 ml of water; these 20 ml of water are collected and made up to 25 ml with water and then the turbidity of these 25 ml of water is determined with a Hach turbidimeter. The turbidity found is expressed in NTU units (the lower the turbidity values, the better the wet abrasion resistance of the coating) and the results obtained are reported in Table 3 below.

TABLE 3
Turbidity values

| | F 0 | F1 | F 4 | F 5 | F 6 | F 7 | F 8 | F 9 | F 10 | F 11 |
|---|---|---|---|---|---|---|---|---|---|---|
| Turbidity | 218 | 152 | 218 | 37 | 40 | 50 | 54 | 107 | 28 | 29 |
| (in NTU) | | | | | | | | | | |

The analysis of the results mentioned in table 3 shows, that with respect to the coating slips prepared according to the prior art (comparative formulation F4, using ZDG cannot provide a coating having a sufficient wet abrasion resistance.

The formulations F5-F11 according to the present invention, however, provide coatings having an improved wet abrasion resistance.

Other advantages of the composition according to the present invention are a very rapid preparation and only a very slight smell of ammonia.

1. Aqueous composition comprising a complex comprising at least one polyvalent metal, wherein the at least one polyvalent metal is complexed by at least one carbonate ligand and at least one carboxylic acid ligand, optionally wherein the carboxylic acid ligand is functionalized with at least one further hydrophilic group.

2. Composition according to claim 1, wherein the at least one polyvalent metal is selected from transition metals and main group metals, optionally wherein the at least one polyvalent metal is zinc or aluminum.

3. Composition according to claim 1, wherein the source of the at least one polyvalent metal is selected from the corresponding metal carbonate, metal chloride, metal oxide, metal sulphate, and combinations or mixtures thereof, optionally selected from zinc carbonate, zinc chloride (ZnCl2), zinc oxide, zinc sulphate, aluminium oxide, aluminum sulphate, aluminum chloride (AlCl3) and combinations or mixtures thereof.

4. Composition according to claim 1, wherein the molar ratio between the at least one carbonate ligand and the at least one carboxylic acid ligand is at least about 10 molar %, optionally at least about 20 molar %, optionally at least about 30 molar %, and up to about 65 molar %, optionally up to about 60 molar %, optionally up to about 50 molar %, optionally between about 30 and about 50 molar % of carbonate ligand; and at least about 35 molar %, optionally at least about 40 molar %, optionally at least about 50 molar %, and up to about 90 molar %, preferably up to about 80 molar %, and most preferably up to about 70 molar %, optionally between about 50 and about 70 molar % of carboxylic acid ligand,
wherein the amount of carboxylic acid ligand and carbonate ligand is in total 100 molar %.

5. Composition according to claim 1, wherein the at least one carboxylic acid ligand is functionalized with at least one further hydrophilic group.

6. Composition according to claim 5, wherein the hydrophilic group is selected from: alcohol group, amine group, amide group, sulfonic acid group, carboxylic acid group, ester group, phosphorus-oxygen acid group, carbonate group, and combinations thereof.

7. Composition according to claim 1, wherein the source of the at least one carbonate ligand is selected from an inorganic carbonate salt, optionally from sodium hydrogenocarbonate, ammonium carbonate, ammonium hydrogenocarbonate, potassium hydrogenocarbonate, and combinations or mixtures thereof.

8. Composition according to claim 1, wherein the source of the at least one carboxylic acid ligand is selected from glycolic acid, lactic acid, glycine, and combinations or mixtures thereof.

9. Composition according to claim 1, wherein the source of the at least one polyvalent metal is selected from zinc oxide, zinc carbonate, and combinations or mixtures thereof; and
the source of the at least one carbonate ligand is selected from potassium hydrogenocarbonate, ammonium hydrogenocarbonate, and combinations or mixtures thereof; and
the source of the at least one carboxylic acid ligand is selected from glycolic acid, lactic acid, glycine, and combinations or mixtures thereof.

10. Composition according to claim 1, wherein the pH value of the composition is alkaline, optionally more than 7, or more than about 8, or more than about 9, and less than about 10.

11. Composition according to claim 1, wherein the concentration of Zn ions, expressed as ZnO, is in the range of from about 3 to about 20% by weight.

12. Composition according to claim 1, wherein the composition further comprises at least one additive, optionally selected from the group consisting of stabilizing agents.

13. Method of manufacturing of the composition according to claim 1 comprising admixing at least one salt of a polyvalent metal with at least one carbonate salt and at least one carboxylic acid.

14. Method of coating a fiber-based substrate, optionally a cellulose-based substrate, optionally a paper, board, non woven or textile substrate, comprising contacting said substrate with the composition of claim 1.

15. A composition according to claim 1, suitable for use as an insolubilizing agent in an aqueous composition for the treatment, optionally impregnation or coating, of a fiber-based substrate, optionally a cellulose-based substrate, optionally paper, board, non woven or textile material.

16. Pigmented coating bath comprising the composition according to claim 1.
